(19) United States
(12) Patent Application Publication
(10) Pub. No.: US 2011/0106872 A1
(43) Pub. Date: May 5, 2011

(54) Method and apparatus for providing an area-efficient large unsigned integer multiplier

(76) Inventors: William Hasenplaugh, Boston, MA (US); Gilbert Wolrich, Framingham, MA (US); Vinodh Gopal, Westboro, MA (US); Gunnar Gaubatz, San Jose, CA (US); Erdinc Ozturk, Worcester, MA (US); Wajdi Feghali, Boston, MA (US)

(21) Appl. No.: 12/157,074

(22) Filed: Jun. 6, 2008

(51) Int. Cl. G06F 7/487

(52) U.S. Cl. 708/631

(57) ABSTRACT

An area efficient multiplier having high performance at modest clock speeds is presented. The performance of the multiplier is based on optimal choice of a number of levels of Karatsuba decomposition. The multiplier may be used to perform efficient modular reduction of large numbers greater than the size of the multiplier.

### FIELD

This disclosure relates to multipliers and in particular to large unsigned integer multipliers.

### BACKGROUND

The schoolbook method (classical approach) to multiply two polynomials is to multiply each term of a first polynomial by each term of a second polynomial. For example, a first polynomial of degree 1 with two terms a₁x+a₀ may be multiplied by a second polynomial of degree 1 with two terms b₁x+b₀ by performing four multiply operations and three addition operations to produce a polynomial of degree 2 with three terms as shown below:

(a₁x+a₀)(b₁x+b₀)=a₁b₁x²+(a₀b₁x+a₁b₀x)+a₁b₁

The number of multiply operations and additions increases with the number of terms in the polynomials. For example, using the schoolbook method, the number of multiply operations to multiply two polynomials each having n terms is n² and the number of additions is (n−1)².

The Karatsuba (KA) algorithm reduces the number of multiply operations compared to the schoolbook method by multiplying two two-term polynomials (A(x)=(a₁x+a₀) and B(x)=(b₁x+b₀)), each having two coefficients ((a₁,a₀) and (b₁ b₀)), using three scalar multiplications instead of four multiplications as shown below:

C(x)=(a₁x+a₀)(b₁x+b₀)=a₁b₁x²+((a₀+a₁)(b₀+b₁)−a₀b₀−a₁b₁)x+a₀b₀

Thus, four additions and three multiplications are required to compute the result C(x) of multiplying two two-term polynomials using the KA algorithm. The KA algorithm relies on the ability to perform shift operations faster than a standard multiplication operation.

Encryption/decryption operations typically require integer multiply operations to be performed on large operand sizes, for example, 512-bit operands. This is typically implemented in a large core hardware multiplier.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system that includes an integer multiplier that provides the result of multiplying a multiplier and a multiplicand each having more than 64-bits according to the principles of the present invention;

FIG. 2 is a pictorial representation of two operands (A, B) each having 512-bits;

FIG. 3 is a pictorial representation of a large multiply operation decomposed into a plurality operations performed in a small multiplier using the KA algorithm;

FIG. 4 is a block diagram illustrating an embodiment of the large multiplier shown in FIG. 1:

FIG. 5A-5B is a block diagram of an embodiment of a Karatsuba Multiplier unit in the integer multiplier unit shown in FIG. 4 according to the principles of the present invention;

FIG. 6 illustrates a 27-element triangle decomposition performed in the phase 0 interface for one of the four k-bit sub-segments;

FIG. 7 illustrates an embodiment of a data flow to perform recombination in the phase 1 interface;

FIG. 8 illustrates an embodiment of a data flow to perform recombination in the phase 2 interface; and

FIG. 9 illustrates an embodiment of a data flow to perform recombination in the phase 3 interface.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

Examples of multipliers that operate on operands (multiplier/multiplicand) having 8 through 64 bits include multipliers that use an array-multiplier organization, a shift accumulate algorithm and tree-based multipliers such as Wallace or Dadda. However, these multipliers do not scale well for operand sizes greater than 64-bits.

The Karatsuba (KA) algorithm reduces the number of multiply operations compared to the schoolbook method by multiplying two two-term polynomials (A(x)=(a₁x+a₀) and B(x)=(b₁x+b₀)), each having two coefficients ((a₁, a0) and (b1 b₀)), using three scalar multiplications instead of four multiplications

In an embodiment of the present invention, a multiplication problem having an operand size greater than 64-bits is decomposed using the KA algorithm into a plurality of multiplication operations that operate on operands having less than or equal to 64-bits. The decomposition allows techniques used in multipliers that operate efficiently on operands in the range 8 through 64-bits to be combined in a modular fashion. The decomposition of large multiply operations (operating on operands greater than 64-bits) into small multiply operations (operating on operands in the range 8 through 64-bits) results in fewer multiply operations at the expense of more additions/subtractions.

In an embodiment of the present invention, a large integer multiplier unit includes a small multiplier block to perform a sequence of small multiply and add/subtract operations efficiently using the KA algorithm.

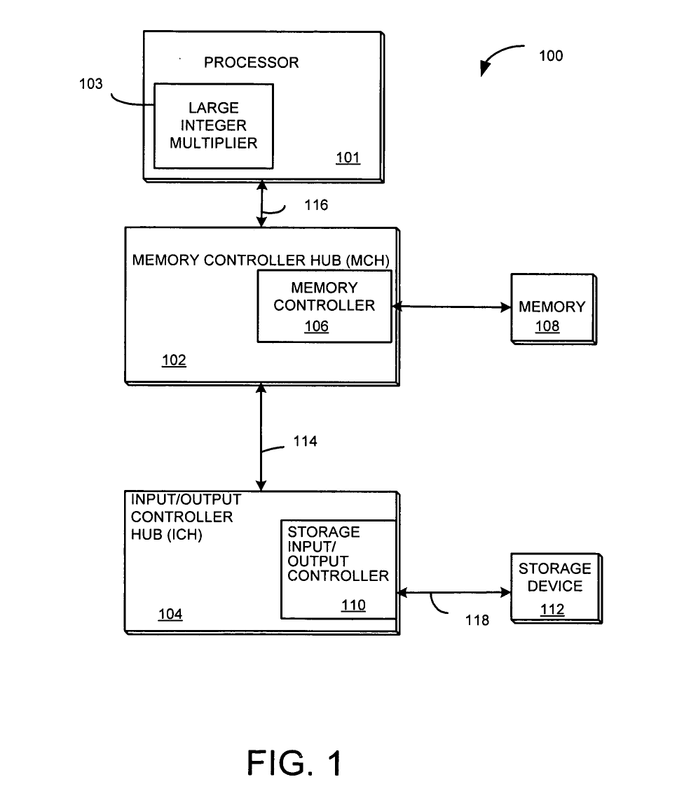

FIG. 1 is a block diagram of a system 100 that includes an integer multiplier that provides the result of multiplying a multiplier and multiplicand each having more than 64-bits according to the principles of the present invention.

The system 100 includes a processor 101, a Memory Controller Hub (MCH) 102 and an Input/Output (I/O) Controller Hub (ICH) 104. The MCH 102 includes a memory controller 106 that controls communication between the processor 101 and memory 108. The processor 101 and MCH 102 communicate over a system bus 116. In an alternate embodiment, the functions in the MCH 102 may be integrated in the processor 101 and the processor 101 coupled directly to the ICH 104.

The processor 101 may be any one of a plurality of processors such as a single core Intel® Pentium IV® processor, a single core Intel Celeron processor, an Intel® XScale processor or a multi-core processor such as Intel® Pentium D, Intel® Xeon® processor, or Intel® Core® Duo processor or any other type of processor.

The memory 108 may be Dynamic Random Access Memory (DRAM), Static Random Access Memory (SRAM), Synchronized Dynamic Random Access Memory (SDRAM), Double Data Rate 2 (DDR2) RAM or Rambus Dynamic Random Access Memory (RDRAM) or any other type of memory.

The ICH 104 may be coupled to the MCH 102 using a high speed chip-to-chip interconnect 114 such as Direct Media Interface (DMI). DMI supports 2 Gigabit/second concurrent transfer rates via two unidirectional lanes.

The ICH 104 may include a storage I/O controller 110 for controlling communication with at least one storage device 112 coupled to the ICH 104. The storage device may be, for example, a disk drive, Digital Video Disk (DVD) drive, Compact Disk (CD) drive, Redundant Array of Independent Disks (RAID), tape drive or other storage device. The ICH 104 may communicate with the storage device 112 over a storage protocol interconnect 118 using a serial storage protocol such as, Serial Attached Small Computer System Interface (SAS) or Serial Advanced Technology Attachment (SATA).

The processor 101 includes a large integer multiplier 103 to perform multiplication problems, that is, to compute the result of multiplying a multiplier and a multiplicand. The multiplication problems (operations) may be used to encrypt or decrypt information stored in memory 108 and/or stored in the storage device 112.

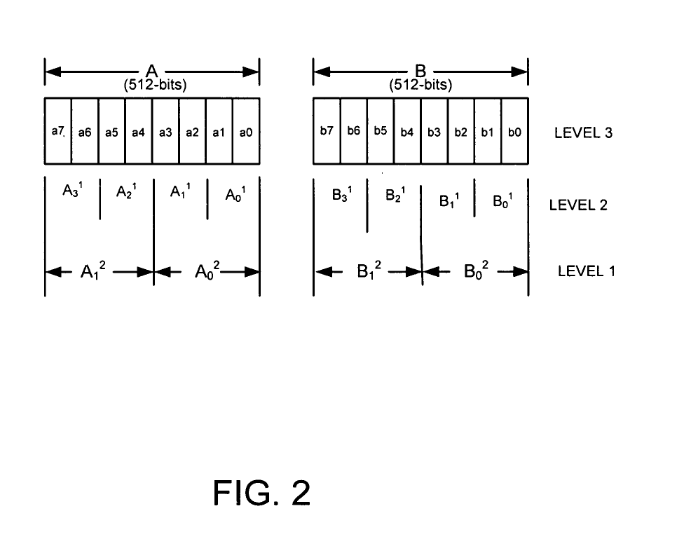

FIG. 2 is a pictorial representation of two operands (A, B) each having 512-bits. Referring to FIG. 2, operands A and B each have 512-bits and a product C (=A×B) has 1024-bits. The 512-bit operands A and B may each be represented as an 8-element vector, with each element having 64-bits. The 64-bit elements are labeled a7-a0 and b7-b0 in FIG. 2. The number of elements is chosen to match a number of levels of decomposition. The number of elements is 2̂N for N levels of decomposition. Thus, 8 elements provide 3 levels of decomposition (2̂3=8).

In an embodiment of the present invention, the 512×512 “large” multiply operation is decomposed into a plurality of 64×64 “small” multiply operations. The decomposition of large multiply operations into a plurality of small KA multiply operations results in fewer multiply operations at the expense of more additions and subtractions.

Referring to FIG. 2, 512-bit operands A and B are each subdivided into two 256-bit segments labeled A₁², A₀², B₁², B₀² and each of these 256-bit segments are further subdivided into two 128-bit segments labeled A¹₃, A¹₂, A¹₁, A¹₀, A¹₃, A¹₂, B¹₁, B¹₀. Each of these 128-bit segments are further subdivided into two 64-bit segments labeled a7-a0, and b7-b0. In an embodiment, the “small” multiply operations are performed using the KA algorithm (KA multiplication) in a small multiplier that operates on 64-bit segments of the 512-bit operands.

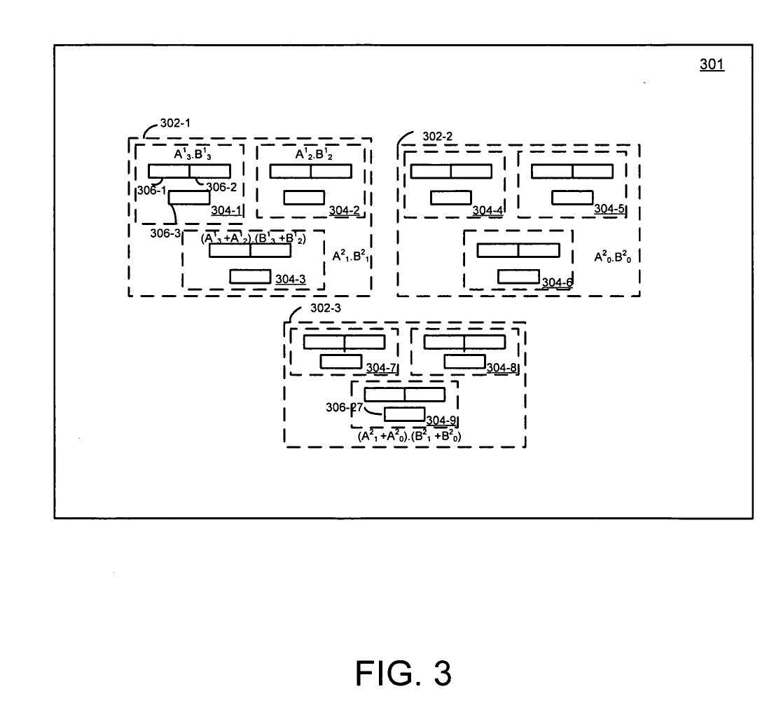

FIG. 3 is a pictorial representation of a 512-bit×512-bit multiply operation decomposed into a plurality of 64-bit×64-bit operations performed using the KA algorithm. The 512×512 multiply operation of a 512-bit multiplicand and a 512-bit multiplier to compute a 1024-bit product is decomposed into three levels. FIG. 3 will be described in conjunction with FIG. 2.

The Karatsuba algorithm requires 3 multiply operations to multiply two two-term polynomials (A(x)=(a₁x+a₀) and B(x)=(b₁x+b₀)), each having two coefficients ((a₁, a0) and (b1 b₀)), as shown below:

$$\begin{matrix}C ( x ) = ( {a}_{1} x + {a}_{0} ) ( {b}_{1} x + {b}_{0} ) \\ = {a}_{1} {b}_{1} {x}^{2} + ( ( {a}_{0} + {a}_{1} ) ( {b}_{0} + {b}_{1} ) - {a}_{0} {b}_{0} - {a}_{1} {b}_{1} ) x + {a}_{0} {b}_{0}\end{matrix}$$

The three multiply operations are: (1) a₁ b₁; (2) a₀ b₀ and (3) ((a₀+a₁) (b₀+b₁). The first two multiply operations (1) a₁ b₁ and (2) a₀ b₀ use t-bit operands, whereas the other multiply operation (3) (a₀+a₁) (b₀+b₁) uses (t+1)-bit operands.

As shown in FIG. 3, the 512-bit multiplication may be decomposed into three levels. There are three second levels in each first level and nine third levels in each second level. Thus, with 3-levels of decomposition, 27 (3×9) 64-bit×64-bit multiply operations are used to compute the result of the 512-bit×512-bit multiply operation.

The first level of decomposition subdivides 512-bit multiplier (operand) A and 512-bit multiplicand (operand) B into two 256-bit sub-elements (for example, A₁², A₀², B₁², B₀² (FIG. 2)) The first level performs the Karatsuba algorithm on the 256-bit sub-elements. The first level operations correspond to the three first level operations 302-1, 302-2, 302-3 that operate on 257-bit operands (256-bit sub-element data plus 1 carry bit).

The second level of decomposition subdivides the two 256-bit sub-elements from the first level into two 128-bit sub-elements (for example, A¹₃, A¹₂, A¹₁, A¹₀, B¹₃, B¹₂, B¹₁, B¹₀(FIG. 2)). The 128-bit sub-elements are the result of multiplying two of the eight 64-bit sub-elements. Each first level operation includes three second level operations 304-1, . . . , 304-9 that operate on 130-bit operands (128-bit data plus 2 carry bits).

Each second level operation includes 3 third level operations that each perform a 68-bit (64-bit data plus 3 carry bits) multiply operation using the “small” multiplier block. As shown in FIG. 3, second level operation 304-1 includes three third level operations 306-1, 306-2, and 306-3. Thus, there are 27 third level operations resulting in 27 multiply operations.

In the embodiment shown, the number of levels is three, however, the number of levels is not limited to three. The number of levels used is dependent on the performance required, the size of the multiplier and the cost of additional add and subtraction operations that require extra registers for storage.

Referring to FIG. 3, in the first level, the A×B multiply operation is decomposed into a KA multiply operation that computes the following:

C(x)=A²₁·B²₁x²+((A²₁+A²₀)·(B²₁+B²₀)−A²₀·B²₀−A²₁·B²₁)x+A²₀·B²₀

There are three multiply operations: (i) A²₁·B²₁ performed in 302-1(ii) A²₀·B²₀ performed in 302-2 and (iii) (A²₁+A²₀)·(B²₁+B²₀, performed in 302-3. As shown in FIG. 2, A²₁ includes segments a7-a4; A²₀ includes segments a3-a0; B²₁ includes segments b7-b4; and B²₀ includes segments b3-b0.

In the second level, each of the first level operations is decomposed into a KA multiplication with each of the second levels 304-1 . . . , 304-9 having three multiply operations. For example, the three second level multiply operations decomposed from first level 302-1 are: (i) A¹₃·B¹₃ performed in 304-1(ii) A¹₂·B¹₂ performed in 304-2 and (iii) (A¹₃+A¹₂)·(B¹₃+B¹₂) performed in 304-3. As shown in FIG. 2, A¹₃ includes segments a7-a6; A¹₂ includes segments a5-a4; B¹₃ includes segments b7-b6; and B¹₂ includes segments b5-b4.

In the third level, each of the second level operations is decomposed into a KA multiplication with each of the third levels having three multiply operations. For example, the three third level multiply operations decomposed from second level 304-1 are: (i) a7·b7 performed in 306-1(ii) a6·b6 performed in 306-2 and (iii) (a7+a6)·(b7+b6) performed in 306-3. Segments a7-a6 and b7-b6 are shown in FIG. 2.

In an embodiment of the invention, 27 multiply operations are performed using 64-bit segments a7:a0 and b7:b0 of the 512-bit operands A, B shown in FIG. 2. The results of the 27 multiply operations in the third level operations are combined to provide the product of the 512-bit multiplier (A) and 512-bit multiplicand (B).

An embodiment of a multiple phase multiplier that performs the 27 multiply operations using 64-bit segments of the 512-bit operands and combines the partial results of the multiply operation to provide a 1024-bit result will be described later in conjunction with FIG. 5A-5B.

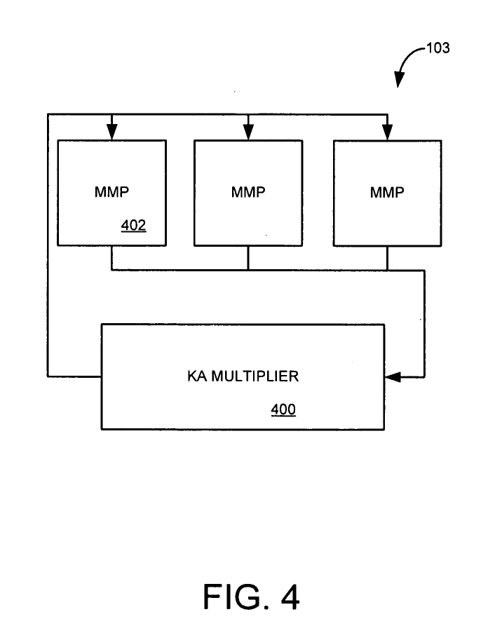

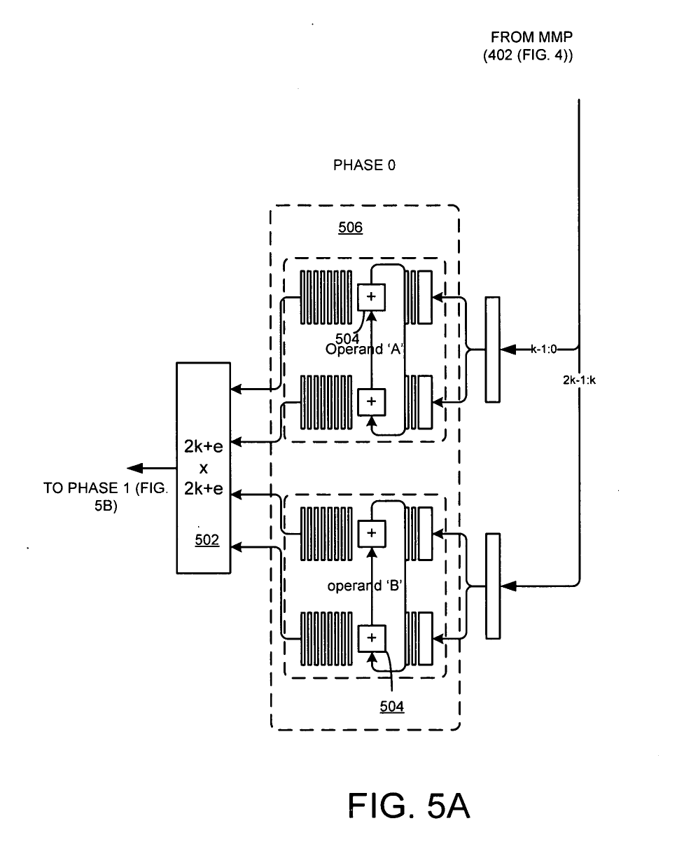

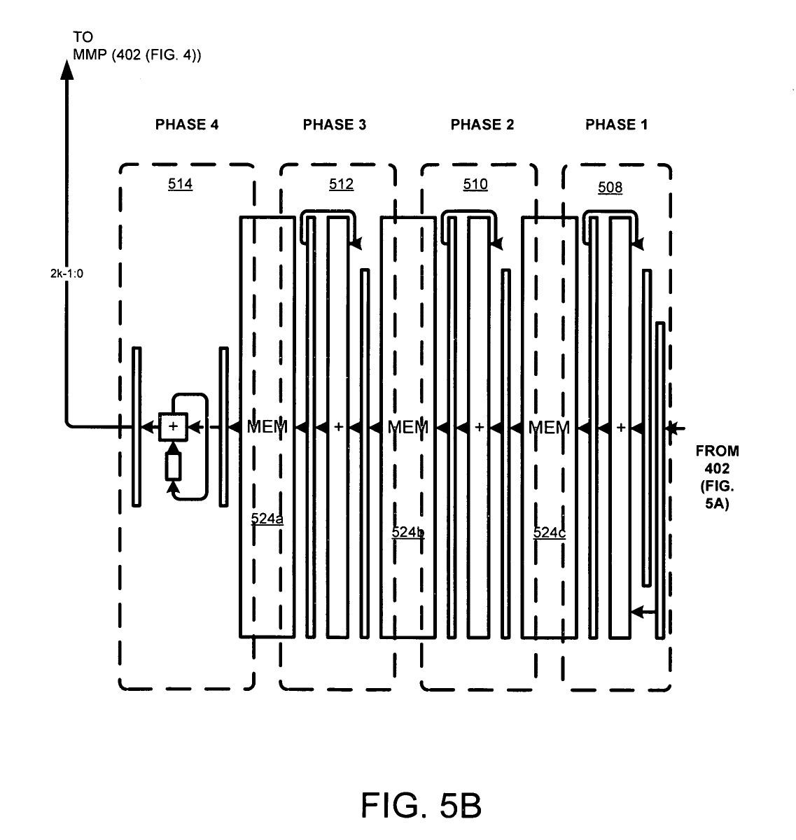

FIG. 4 is a block diagram illustrating an embodiment of the large multiplier 103 shown in FIG. 1. The large multiplier 103 includes at least one modular math processor (MMP) unit 402 and a Karatsuba Multiplier 400. The Karatsuba Multiplier 400 handles the multiplication of two numbers (multiplicand and multiplier) using the Karatsuba Algorithm and provides the output to the MMP 402 in non-redundant form.

A First In First Out memory (FIFO) in the MMP 402 stores the multiplier (A), and the multiplicand (B). The multiplier unit 103 starts working on the multiplier and multiplicand (A, B) of a new problem when it has finished a previous problem and detects that a sufficient portion of the bits of each of the multiplier and multiplicand have been enqueued into result FIFOs in the MMP 402. In an embodiment, the least-significant-words (LSW) are enqueued first. The multiplier unit 103 is designed to operate without stalling to maximize performance.

The multiplier 103 is a (16*k+e−1) by (16*k+e−1) bit multiplier that is fully parameterized using two global variables: k and e. Global variable ‘e’ is derived from the fact that the KA decomposition grows the operands at the Most Significant Bit (MSB). Every recursion of the KA algorithm increments the largest potential Most Significant Bit (MSB) by one. Thus, the selection of e=4 is sufficient to handle multiplication of operands having up to {2̂[10+log 2(k)]−1} bits.

A multiply operation is optimized based on an optimal choice of number of levels of Karatsuba decomposition and the order in which the plurality of (2 k+e)×(2 k+e) multiply operations are performed and the results of the multiply operations are combined. In an embodiment, the Karatsuba Multiplier Unit 400 includes full-adders, a core ((2 k+e)×(2 k×e)) multiplier, Carry Save Adders (CSA)s, and memory such as Random Access Memory (RAM)). Partial products may be sequenced and re-combinations ordered in multiple balanced phases to provide efficient usage of the memory and low latency, largely independent of the operand size. In an embodiment, the KA multiplier unit 400 includes two (k+e) bits carry propagate adders and five k-bit carry propagate adders. K is a power of two in order to simplify the transfer of data to/from 32 bit data paths. The multiplier and multiplicand operands are 2 k-bit wide. In one embodiment, k is 32.

The MMP 402 serializes the data for the multiplier and multiplicand by dividing the multiplier and multiplicand into k-bit segments and sending multiplier and multiplicand data to the multiplier k-bits at a time. In an embodiment, the KA multiplier unit 400 includes five logic blocks (referred to as phase 0-4 interfaces) which will be described in greater detail later in conjunction with FIGS. 5A-5B.

FIG. 5A-5B is a block diagram of an embodiment of the Karatsuba Multiplier unit 400 in the integer multiplier unit 103 shown in FIG. 4 according to the principles of the present invention. The integer multiplier unit 103 performs a (8×2 k)-bit×(8×2 k)-bit multiply operation using a sequence of “small” multiplication operations performed by the KA Multiplier 400.

The “small” multiplication operations use a Karatsuba Multiplier unit 400 that performs multiply operations on operands having 2 k-bits. The results of all of these multiply operations are combined using add/subtract operations spread over a plurality of pipeline stages in the Karatsuba Multiplier 400.

Referring to FIG. 5A, a phase 0 interface 506 in the KA multiplier 400 interacts with one or more MMPs 402 (FIG. 4) to receive data from the MMP 402, provide idle/busy status to the MMP 402 and start the multiplication operation in response to a request received from the MMP 402. The phase 0 interface 506 performs decomposition of all recursion levels in the KA multiplier 400 described in conjunction with FIG. 2 and FIG. 3. The phase 1 through phase 3 interfaces shown in FIG. 5B handle recombination at different levels of the KA Algorithm.

Referring to FIG. 5B, the phase 4 interface 514 converts the redundant form result of the KA Algorithm to a non-redundant form. The Phase 4 interface 514 interacts with one or more MMPs 402, informs the MMP 402 that the output data from the KA multiplier unit 400 is ready to be sent to the MMP 402 and sends the output data to the MMP 402.

Returning to FIG. 5A, the KA multiplier 400 also includes a core multiplier 502 between the Phase 0 interface 506 and the Phase 1 interface 508 to perform the multiplication of the k-bit segments of the operands (multiplicand, multiplier). In addition, memory 524a-c between each phase interface provides temporary storage for data between phase interfaces as one phase interface may complete a problem earlier than another phase interface. Also, as each phase interface has different forms of inputs and outputs, interface logic between each phase interface controls data flow between the phase interfaces. In an embodiment, the interface logic between phase interfaces includes Random Access Memory (RAM) and First In First Out (FIFO) memory.

An embodiment will be described to compute a 1024-bit product of two operands each having 512-bits (that is, k is 32, e is 4). However, the invention is not limited to computing a 1024-bit product of 512-bit operands. The large integer multiplier unit 103 may compute a 2×(N×2^{M})-bit product of two operands each having (N×2^{M})-bits using M-levels of Karatsuba in M² cycles.

In the embodiment shown, the KA Multiplier unit 400 includes a (2 k+e)-bit unsigned core multiplier 502 (integer multiplier block), carry-save accumulator blocks, carry propagate adders, registers and memory 524a-b, that may be Random Access Memory for storing data between phase interfaces. The KA multiplier 400 may also include a state machine for sequencing multiply operations, addition operations and data-transfers to/from input/result First In First Out (FIFO)s in the MMPs 402.

In an embodiment for multiplying a 512-bit multiplicand and a 512-bit multiplier with operands treated as unsigned integers, the Karatsuba multiplier unit 400 takes 27-cycles to compute the 1024-bit product.

In the embodiment shown in FIG. 5A-5B, the KA multiplier 400 includes a 68×68 core multiplier (that is, (2 k+e) with k=32 and e=4) 502 and five logic interfaces labeled phase 0 506, phase 1 508, phase 2 510, phase 3 512 and phase 4 514. The data flow inside the phase 0 interface 506 is divided into two main segments: operand A (multiplicand) and operand B (multiplier). These two segments are further divided into two sub-segments: a low sub-segment and a high sub-segment.

Operand segments each having (2*k)-bits are received from an MMP 402 and stored in memory in the phase 0 interface (block) 506. In an embodiment, the (2*k)-bits are received as two k-bit segments. The first k-bits received has the low order (Least Significant Bits (LSB)) k-bits of the (2*k)-bits segment and the second k-bits received has the high-order (Most Significant Bits (MSB)) k-bits of the (2*k) bits segment.

The phase 0 block 506 includes four propagate adders 504, two for operand A (one for each sub-segment) and two for operand B (one for each sub-segment).

The phase 0 interface 506 also includes a plurality of registers (memory buffers) for performing the level 3 decompositions described in conjunction with FIG. 2 and FIG. 3. A plurality of (2*k-bit) segments of the multiplicand and multiplier are stored in memory in the phase 0 interface 506 to allow various segments to be added in the phase 0 block in each of the 27 cycles. The phase 0 interface 506 also includes carry handling logic for handling carry propagation between the MSB portion and the LSB portion of the sub-segments of each of the operands (A, B).

The phase 0 interface 506 performs the initial additions and multiplications. A 27 element ‘Karatsuba triangle’ is generated given 8 element operands each element having 64-bits. The KA algorithm requires subtractions in the middle section of the triangle as shown below:

C(x)=A²₁·B²₁x²+((A²₁+A²₀)·(B²₁+B²₀)−A²₀·B²₀−A²₁·B²₁)x+A²₀·B²₀

The subtractions ((A²₁+A²₀)·(B²₁+B²₀)−A²₀·B²₀−A²₁·B²₁) are handled separately in combining Carry Save Adders (CSAs) using the ones-complement of the products and compensating at a suitable point in time.

Table 1 below illustrates an embodiment of a schedule of operations performed in 27-cycles in the phase 0 interface 506 to decompose one of the sub-segments of the (2*k)-bits segment.

TABLE 1

| Cycle No. | Operation(s) | |
|---|---|---|
| 1 | | Output = E27 (prior problem) |
| 2 | Add E1 + E2 = E3; | Output = E1 |
| 3 | Add E4 + E1 + C = E7 | Output = E2 |
| 4 | Add E5 + E4 = E6; | Output = E3 |
| 5 | Add E2 + E5 = E8; | Output = E4 |
| 6 | Add E8 + E7 = E9; | Output = E5 |
| 7 | Add E10 + E13 + C = 16; | Output = E6 |
| 8 | Add E11 + E10 = E12; | Output = E7 |
| 9 | Add E14 + E11 = E17; | Output = E8 |
| 10 | | Output = E9 |
| 11 | | Output = E10 |
| 12 | Add E13 + E14 = E15; | Output = E11 |
| 13 | | Output = E12 |
| 14 | | Output = E13 |
| 15 | Add E10 + E1 + C = E19; | Output = E14 |
| 16 | Add E16 + E17 = E18; | Output = E15 |
| 17 | Add E11 + E2 + C = E20; | Output = E16 |
| 18 | | Output = E17 |
| 19 | Add E13 + E4 + C = E22; | Output = E18 |
| 20 | Add E19 + E22 = E25; | Output = E19 |
| 21 | Add E14 + E5 + C = E23; | Output = E20 |
| 22 | Add E19 + E20 = E21 | Output = E21 |
| 23 | Add E23 + E22 = E24; | Output = E22 |
| 24 | Add E23 + E20 = E26; | Output = E23 |
| 25 | | Output = E24 |
| 26 | Add E26 + E25 = E27; | Output = E25 |
| 27 | | Output = E26 |

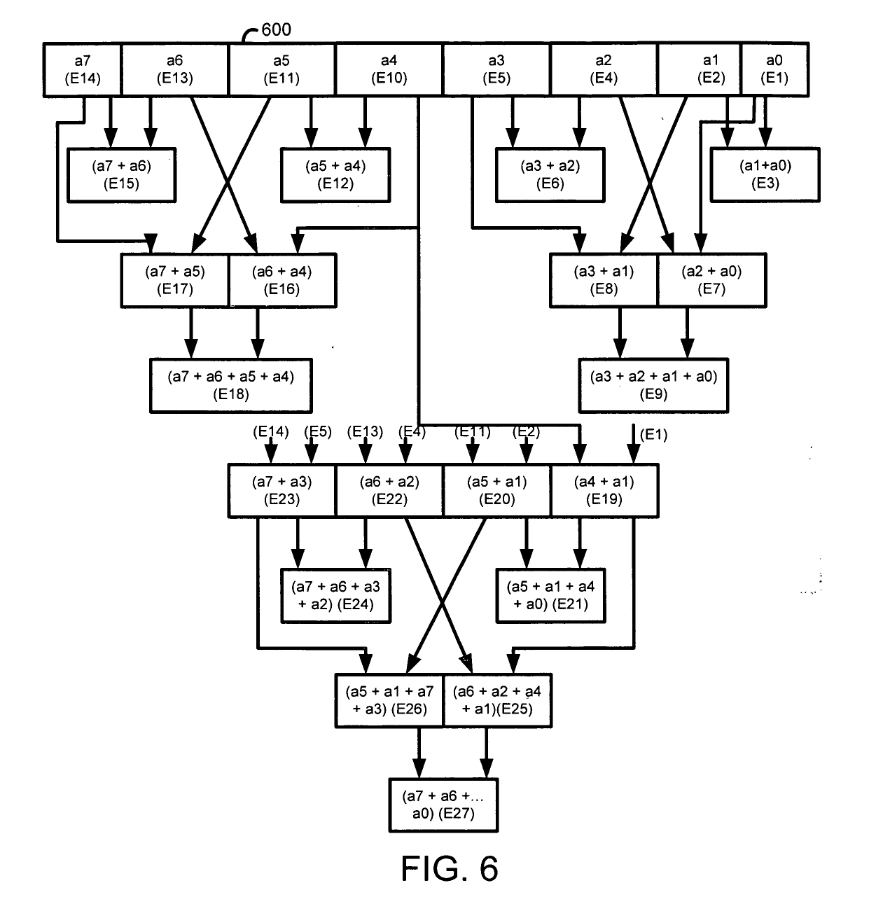

FIG. 6 illustrates a 27-element triangle decomposition performed in the phase-0 interface 506 for one of the four k-bit sub-segments. Table 1 will be described in conjunction with FIG. 6. The 27-elements shown in FIG. 6 correspond to the decompositions of the k-bit sub-segment that are used by the third level operations 306-1, . . . , 306-27 shown in FIG. 3.

The sub-segment (LSB or MSB) of the 512-bit operand includes 256-bits which are further sub-divided into eight 32-bit portions. The LSB sub-segment and the MSB sub-segment are identical other than the carry handling. The carry-in bits for the LSB sub-segment are all zero and may be zero or one for the MSB sub-segment dependent on the result of the operation performed in the LSB sub-segment.

KA multiplication is performed in the core multiplier 502 using one of the 32-bit portions of the LSB sub-segment and the corresponding one of the 32-bit portions of the LSB segment of each respective operand (A, B) which may be referred to as a_{L}0-a_{L}7 for the LSB sub-segment of operand A. Each element 600 in the 27-element triangle shown in FIG. 6 is labeled E1 through E27 in the order in which the elements (E) are output by the phase 0 interface 506 in each of the 27-cycles (1-27) shown in Table 1.

In the example shown in FIG. 6, each of the elements 600 labeled E1, E2, E4, E5, E10, E11, E13 and E14 includes a portion of the multiplier/multiplicand received from the MMP 402. The other elements are decomposed using these elements or using the results of decomposition of these elements. The elements 600 are temporarily stored in memory in the phase 0 interface 506 and output from the phase 0 interface 506 to the core multiplier 502 in numerical order (E1 through E27) according to the schedule shown in Table 1. The decomposition also includes addition of some of these elements based on the schedule shown in Table 1.

As discussed previously, the KA multiplication algorithm performs the following operations:

C(x)=A₁·B₁x²+((A₁+A₀)·(B₁+B₀)−A₀·B₀−A₁·B₁)x+A₀·B₀

Referring to Table 1, the KA multiplication algorithm is performed nine times using different elements 600. The KA multiplication algorithm computes the following nine products using a total of 27 multiply operations: (1) E1·E2; (2) E4·E5; (3) E10·E11; (4) E13·E14; (5) (E1:E2)·(E4:E5); (6) (E10:E11)·(E14:15); (7) E19·E0; (8) E22·E23; and (9) (E22:E19)·(E23:E20). To compute the first of the nine products, that is, (1) E1·E2, the KA multiplication algorithm uses elements labeled E1, E2 and E3 with element labeled E1 corresponding to A₀, element labeled E2 corresponding to A₁ and element labeled E3 corresponding to (A₁+A₀). The decomposition shown in FIG. 6 performs the arithmetic computations for the 32-bit LSBs of each 64-bit segment of the A operand.

In cycle 1 of the 27-cycle KA multiplication, the phase 0 interface 506 outputs the last element (element number 27) associated with the previous problem.

In cycle 2, element E1 of the current problem is output to the core multiplier. For operand A, element E1 includes the LSBs of the LSB sub-segment of the A operand, that is, the 32 LSBs of A₀, which as shown in FIG. 5A is forwarded to the core multiplier together with the MSBs of A₀ and MSBs and LSBs of B₀ to compute the product A₀·B₀. Also, in cycle 2 while element E1 is output to the core multiplier 502, the sum of element E1 and element E2 is computed in carry sum adder 504 to compute the sum A₁+A₀ which is used to compute another of the three products of the KA multiplication algorithm, that is, (A₁+A₀)·(B₁+B₀). The sum is temporarily stored in memory in the phase 0 interface 506 until it is output in cycle 4.

In cycle 3, while the sum of element E1 and element E4 is computed to compute (E1:E2)·(E4:E5) in the carry sum adder, element E2 to compute E1·E2 is output to the core multiplier to compute the last of the three products of the KA algorithm for E1·E2. A carry (C) may also be added to the sum of element E1 and element E4 to provide element E7. As discussed earlier, the carry (C) added to the sum of element E1 and element E4 for the LSB sub-segment is zero. The carry (C) may be zero or one for the MSB sub-segment dependent on the result of the operation performed in the LSB sub-segment.

In cycle 4, while the sum of element E5 and element E4 is computed to compute (E1:E2)·(E4:E5) in the carry sum adder, element 3 (A₁+A₀) is output to the core multiplier to compute the last of the three products of the KA algorithm for the product of E1·E2, that is, (A₁+A₀)·(B₁+B₀).

In cycle 5, while the sum of element 2 and element 5 is computed in the carry sum adder to provide element E8 used to compute (E1:E2)·(E4:E5), element 4, that is, A₂ is output to the core multiplier to compute product (E1:E2)·(E4:E5).

In cycle 6, while the sum of element 8 and element 7 is computed in the carry sum adder to provide element 9 used to compute (E1:E2)·(E4:E5), element 5, that is, A₃ is output to the core multiplier to compute product E4·E5.

In cycle 7, while the sum of element 10 and element 13 is computed in the carry sum adder t to provide element 12 used to compute E10·E11, element 7 is output to the core multiplier to compute (E1:E2)·(E4:E5).

In cycle 8, while the sum of element 10 and element 11 is computed in the carry sum adder t to provide element 12 to computer E10·E11, element 8 is output to the core multiplier to compute (E1:E2)·(E4:E5).

In cycle 9, while the sum of element 14 and element 11 is computed in the carry sum adder t to provide element 17 to compute (E10:E11)·(E14:15), element 9 is output to the core multiplier to compute E10·E11.

In cycle 10, element 10 is output to the core multiplier to compute E10·E11.

The remaining cycles 11 through 27 follow a similar pattern to cycles 1 to 10 as shown in Table 1 to compute the remainder of the nine KA multiplication operations.

The core multiplier 502 computes all of the partial products of the KA Algorithm as discussed earlier. The core multiplier receives two (2*k+e)-bit operands from the phase 0 interface and outputs a (4*k+2*e)-bit result in redundant form to the phase 1 interface (block). In an embodiment, the core multiplier may be pipelined in order to decrease the delay of the critical path.

The core multiplier 502 computes the result of multiplying a 68 bit multiplicand and a 68 bit multiplier. The result is a 136 bit partial product. The order of the plurality of 68 bit×68 bit multiply operations is fixed as discussed in conjunction with the sequence of operations performed by the phase 0 interface in Table 1 and is chosen to reduce latency and minimize storage space in registers in the multiply unit 100. The 136-bit product is generated in carry-save redundant (CSR) format.

The partial products are combined with previous accumulated partial results (also in carry-save redundant format) in the carry-save accumulator blocks in each of the phase interfaces.

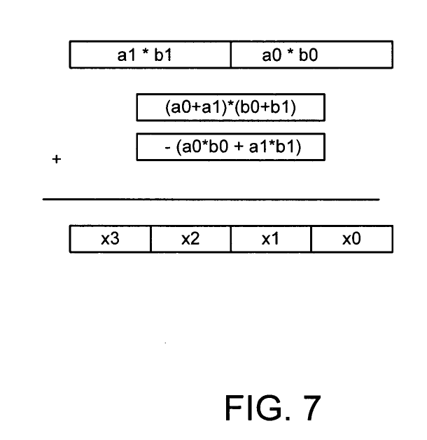

FIG. 7 is a block diagram that illustrates the data flow to perform recombination in the phase 1 interface 508.

The phase 1 interface (module/block) 508 performs recombination of the lowest level recursion level. For example, the phase 1 interface 508 performs the recombination of the second lowest recursion level of the KA Algorithm, that is, first level operations 302-1, 302-2, 302-3, . . . 302-27. The recombination is performed using elements numbered 1, 2, 3 in FIG. 6 as shown in FIG. 7 and will be described in conjunction with FIG. 5A-5B.

First, the 128-bit products (a0*b0) and (a1*b1) received from the core multiplier plus carry bits are added in a carry save adder and the result of the computation is inverted to provide −(a0*b0+a1*b1). Next, the product (a0+a1)*(b0+b1) received from the core multiplier 504 is added in the carry save adder to −(a0*b0+a1*b1). The result of these two operations, that is, recombination (x1, x2) is forwarded to the phase 2 interface 510.

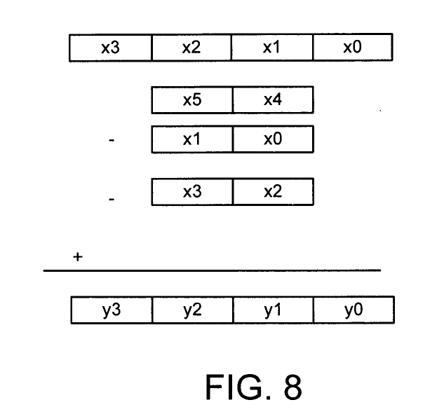

FIG. 8 illustrates an embodiment of a data flow to perform recombination in the phase 2 interface 510. The phase 2 interface 510 receives segments labeled (x0, x1, x2, x3, x4, x5) that are produced by the three lowest levels in the Phase 1 module and performs nine passes through an adder to compute four output segments (y0, y1, y2, y3) using one or more of the four segments in each pass. Each of the six input segments (x0, x1, x2, x3, x4, x5) has 4 k bits, and the phase 2 interface 510 has a single 4 k-bit adder. Thus, the phase 2 interface 510 performs recombination by performing operations segment by segment.

In the first pass, the segment x0 received from the phase 1 interface 508 is passed through the 4 k adder with the other adder inputs set to 0 to the phase 3 interface 512. This value is output as y0.

In the second pass, −(x0+x2) is calculated by the adder and temporarily stored in memory for use in the next pass through the adder.

In the third pass, the result of the second pass is added to x1 to compute x1−(x0+x2). The result is stored in memory for use in the next pass.

In the fourth pass, the result of the third pass is added to x4 to compute x4+x1−(x0+x2). The result is stored in memory for use in the next pass and output as y2, the second segment of the output (y1) of the phase 2 module.

In the fifth pass, x1 passes through the adder with the other adder inputs set to 0. The value x1 is stored in memory for use in the next pass.

In the sixth pass, x3 and the result of the fifth pass (x1) are added to compute −(x1+x3). The result is stored in memory for use in the next pass.

In the seventh pass, x2 and the result of the sixth pass are added to compute x2−(x1+x3). The result is stored in memory for use in the next pass.

In the eighth pass, x5 and the result of the seventh pass are added to compute x5+x2−(x1+x3). The result is forwarded to the phase 3 module as the third segment of the output (y2).

In the ninth pass, x3 passes through the adder with the other adder inputs set to 0 and forwarded to the phase 3 module as the fourth segment of the output (y3).

These nine passes through the adder in the phase 2 module occur three times per problem. Every recursive iteration operates for one segment of the output. The nine passes discussed above construct four recursive iterations of addition, each iteration handling one segment.

The phase 3 interface 512 handles the recombination of the highest recursion level of the KA Algorithm for the three levels shown in FIG. 3, that is, operation 301 (FIG. 3).

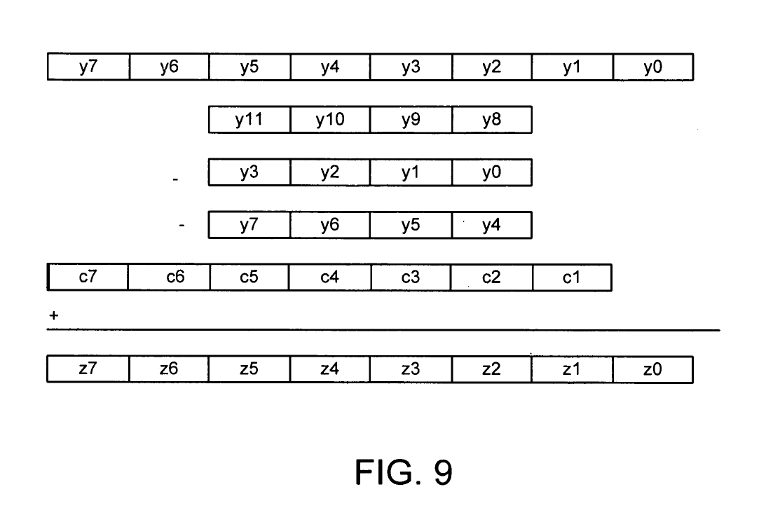

FIG. 9 illustrates an embodiment of a data flow to perform recombination in the phase 3 interface 512. The addition passes in the phase 3 module are similar to the nine passes discussed in conjunction with FIG. 8. The addition is also performed segment by segment with multiple passes through the adder to add all of the segments and output the result segment. In addition to adding all of the segments as discussed in conjunction with the phase 2 module, the phase 3 module also adds correction constants (c1, c2, . . . ) to each segment. Thus, there is one additional pass through the adder to add the respective correction constant.

The phase 4 interface 514 performs conversion of the redundant output of the phase 3 module (z7, . . . z0) into non-redundant form. The phase 4 interface 514 includes a carry-propagation adder that retires 64-bit result words. The carry-propagation adder in the phase 4 interface 514 returns a non-redundant result. The data output from the phase 4 interface 514 is sent through separate First In First Out (FIFO) blocks as low order data and high order data back to the MMP 402.

The combining CSA phases (phase interfaces 1-3 508, 510, 512) are decomposed into phases that are well-balanced in terms of critical paths and correspond to the level of recursion in the Karatsuba algorithm. The width of the CSA phases is optimized for area; when a larger sum is required in a phase, it is performed in multiple cycles dependent on the latency (delay) before the sum is needed for a subsequent operation.

The 512-bit×512-bit multiply operation is performed using a sequence of multiplication operations using the “small” 68-bit×68-bit multiplier and combining add/subtract operations on the results of the small multiply operations spread over a plurality of pipeline stages. The sequence of multiply and add/subtract operations is performed efficiently using a hardware implementation of the KA algorithm using carry-save adders (CSA). A CSA computes the sum of three or more n-bit numbers and outputs a partial sum and carry bit(s).

The ordering of partial results (partial sum and carry bit(s)) from each level affects the overall propagate size, the number and width of CSAs, the number and width of carry-propagate adders, the registers and memory required.

An embodiment of the invention has been described for 512-bit operands. In other embodiments other operand sizes such as 256-bit or 1024-bit may be used.

Performance is optimized based on selection of the number of levels of Karatsuba decomposition, the organization of the full-adders, multiplier, Carry Save Adders (CSAs), and memory, the sequencing of partial products and ordering of recombinations in multiple balanced phases with efficient usage of memory and low latency. Latency is independent of the operand size.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

1. An apparatus comprising:
a Karatsuba multiplier to compute Karatsuba sub-products of a N-bit portion of a (N×2^{M})-bit multiplier and an N-bit portion of (N×2^{M})-bit multiplicand; and
logic to combine M³ Karatsuba subproducts resulting from M levels of Karatsuba multiplication performed by the Karatsuba multiplier for the 2^{M} N-bit portions of the (N×2^{M})-bit multiplier and the 2^{M} N-bit portions of the (N×2^{M})-bit multiplicand to provide a 2(N×2^{M})-bit product.

2. The apparatus of claim 1, wherein N is 64 and M is 3.

3. The apparatus of claim 1, wherein the logic further comprises:
a carry save adder to combine the M³ Karatsuba subproducts.

4. The apparatus of claim 1, wherein the logic further comprises:
decomposition logic to perform decomposition of recursion levels to provide portions of the multiplier and multiplicand to the Karatsuba multiplier for each of the M levels of Karatsuba multiplication.

5. The apparatus of claim 1, wherein the logic further comprises:
memory to store intermediate results to combine M³ Karatsuba subproducts.

6. A method comprising:
computing Karatsuba sub-products of a N-bit portion of a (N×2^{M})-bit multiplier and an N-bit portion of (N×2^{M})-bit multiplicand; and
combining M³ Karatsuba subproducts resulting from M levels of Karatsuba multiplication performed by the Karatsuba multiplier for the 2^{M} N-bit portions of the (N×2^{M})-bit multiplier and the 2^{M} N-bit portions of the (N×2^{M})-bit multiplicand to provide a 2(N×2^{M})-bit product.

7. The method of claim 6, wherein N is 64 and M is 3.

8. The method of claim 6, wherein the combining M³ Karatsuba subproducts is performed using a carry save adder.

9. The method of claim 6, further comprising:
performing decomposition of recursion levels to provide portions of the multiplier and multiplicand for each of the M levels of Karatsuba multiplication.

10. The method of claim 6, further comprising:
storing intermediate results used to combine the M³ Karatsuba subproducts.

11. An article including a machine-accessible medium having associated information, wherein the information, when accessed, results in a machine performing:
computing Karatsuba sub-products of a N-bit portion of a (N×2^{M})-bit multiplier and an N-bit portion of (N×2^{M})-bit multiplicand; and
combining M³ Karatsuba subproducts resulting from M levels of Karatsuba multiplication performed by the Karatsuba multiplier for the 2^{M} N-bit portions of the (N×2^{M})-bit multiplier and the 2^{M} N-bit portions of the (N×2^{M})-bit multiplicand to provide a 2(N×2^{M})-bit product.

12. The article of claim 11, wherein N is 64 and M is 3.

13. The article of claim 11, wherein the combining M³ Karatsuba subproducts is performed using a carry save adder.

14. The article of claim 11, further comprising:
performing decomposition of recursion levels to provide portions of the multipliers and multiplicands for each of the M levels of Karatsuba multiplication.

15. The article of claim 11, further comprising:
storing intermediate results used to combine the M³ Karatsuba subproducts.

16. A system comprising:
a dynamic random access memory; and
a processor coupled to the dynamic random access memory, the processor including an integer multiplier, the integer multiplier comprising:
a Karatsuba multiplier to compute Karatsuba sub-products of a N-bit portion of a (N×2^{M})-bit multiplier and an N-bit portion of (N×2^{M})-bit multiplicand; and
logic to combine M³ Karatsuba subproducts resulting from M levels of Karatsuba multiplication performed by the Karatsuba multiplier for the 2^{M} N-bit portions of the (N×2^{M})-bit multiplier and the 2^{M} N-bit portions of the (N×2^{M})-bit multiplicand to provide a 2(N×2^{M})-bit product.

17. The system of claim 16, wherein N is 64 and M is 3.

18. The system of claim 16, wherein the logic further comprises:
a carry save adder to combine the M³ Karatsuba subproducts.

19. The system of claim 16, wherein the logic further comprises:
decomposition logic to perform decomposition of recursion levels to provide portions of the multiplier and multiplicand to the Karatsuba multiplier for each of the M levels of Karatsuba multiplication.

20. The system of claim 16, wherein the logic further comprises:
memory to store intermediate results to combine M³ Karatsuba subproducts.
